(19) United States
(12) Patent Application Publication
(10) Pub. No.: US 2009/0159048 A1
(43) Pub. Date: Jun. 25, 2009

(54) Injected Fuel Pressure Boosting Device

(75) Inventors: Takafumi Yamada, Susono-shi (JP); Yoshimasa Watanabe, Sunto-gun (JP); Hirokuni Tomita, Okazaki-shi (JP); Yoshihisa Yamamoto, Kariya-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); NIPPON SOKEN, INC, NISHIO-SHI (JP); DENSO CORPORATION, KARIYA-SHI (JP)

(21) Appl. No.: 12/225,210

(22) PCT Filed: Mar. 20, 2007
(86) PCT No.: PCT/JP2007/056525

§ 371 Date: Dec. 15, 2008

(30) Foreign Application Priority Data
Mar. 23, 2006 (JP) 2006-081429

(51) Int. Cl. F02M 63/00

(52) U.S. Cl. 123/447; 123/456

(57) ABSTRACT

An injected fuel pressure boosting device provided with a large diameter piston, a medium diameter piston, and a small diameter piston. A high pressure chamber filled at high pressure at all times is formed at the outer end of the medium diameter pistons, while a pressure boosting chamber is formed at the outer end of the small diameter piston. A pressure control chamber is formed on the end face of the large diameter piston on the small diameter piston side. When high pressure fuel is supplied to the pressure control chamber, the large diameter piston moves to the medium diameter piston side, that is, the pressure boosting preparation position. At this time, the leaked fuel outflow port is closed by the end face of the large diameter piston.

### TECHNICAL FIELD

The present invention relates to an injected fuel pressure boosting device.

### BACKGROUND ART

In a fuel injection apparatus provided with a common rail, known in the art is an injected fuel pressure boosting device provided with a large diameter piston slidably inserted in a large diameter cylinder chamber, a medium diameter piston formed at one end of the large diameter piston, and a small diameter piston coupled with the other end of the large diameter piston, a high pressure chamber filled with high pressure fuel in the common rail is formed on the end face of the outer end portion of the medium diameter piston, a pressure boosting chamber for increasing the pressure of the injected fuel is formed on the end face of the outer end portion of the small diameter piston, and the pressure control chamber is formed on the end face of the large diameter piston on the small diameter piston side (see U.S. Pat. No. 5,852,997).

In this injected fuel pressure boosting device, the high pressure fuel in the common rail is supplied to the pressure boosting chamber. The pressure control chamber is selectively coupled with the high pressure common rail and low pressure fuel exhaust passage. When the pressure control chamber is coupled with the common rail, the pressure control chamber is filled with the high pressure fuel. At this time, all of the large diameter, medium diameter, and small diameter pistons are stopped at pressure boosting preparation positions where the volume of the pressure boosting chamber becomes the greatest. When boosting the pressure of the injected fuel, the pressure control chamber is coupled to the low pressure fuel exhaust passage. At this time, due to the fuel pressure in the high pressure chamber applied to the outer end of the medium diameter piston, all of the pistons move in the direction reducing the volume of the pressure boosting chamber. As a result, the fuel pressure inside the pressure boosting chamber, that is, the injected fuel pressure, is increased.

When the pressure boosting action of the injected fuel ends, the pressure control chamber is again connected with the common rail. At this time, due to the fuel pressure of the high pressure fuel supplied to the pressure control chamber and the fuel pressure of the high pressure fuel in the pressure boosting chamber, all of the pistons are immediately returned to the pressure boosting preparation positions where the volume of the pressure boosting chamber becomes the maximum. That is, in this injected fuel pressure boosting device, the medium diameter piston is used in addition to the small diameter piston and large diameter piston so that after the end of the pressure boosting action, the small diameter piston and large diameter piston can be immediately returned to the pressure boosting preparation positions by the fuel pressure.

However, in this case, if fuel accumulates in the end space formed in the end face of the large diameter piston on the medium diameter piston side, when the large diameter piston tries to return to the pressure boosting preparation position, the returning movement of the large diameter piston is inhibited by this accumulated fuel. As a result, after the pressure boosting action ends, the large diameter piston will no longer immediately return to the pressure boosting preparation position. Therefore, in this injected fuel pressure boosting device, the end space formed in the end face of the large diameter piston on the medium diameter piston side is prevented from accumulating fuel by forming a fuel exhaust port in constant communication with this end space.

However, as explained above, if the end space formed in the end face of the large diameter piston is in constant communication with the fuel exhaust port, the leaked fuel leaked from the inside of the pressure control chamber through the periphery of the large diameter piston to the inside of the end space, then exhausted from the fuel exhaust port and the leaked fuel leaked from the high pressure chamber through the periphery of the medium diameter piston to the inside of the end space, then exhausted from the fuel exhaust port increase, therefore the problem arises that the energy loss for making the fuel high in pressure is increased.

### DISCLOSURE OF THE INVENTION

An object of the present invention is to provide an injected fuel pressure boosting device able to reduce the amount of leaked fuel by covering a leaked fuel outflow port.

According to the present invention, there is provided an injected fuel pressure boosting device provided with a large diameter piston slidably inserted into a large diameter cylinder chamber and a pair of pistons respectively arranged coaxially the two ends of the large diameter piston in the axial direction and having diameters smaller than the large diameter piston, a pressure boosting chamber for increasing a pressure of injected fuel being formed on an outer end face of one piston among the pair of pistons, a pressure control chamber being formed on an end face of the large diameter piston on the pressure boosting chamber side, a pressure boosting action of the injected fuel being controlled by controlling a fuel pressure in the pressure control chamber, and a leaked fuel outflow port for making a fuel leaked from the pressure control chamber through a periphery of the large diameter piston flow out from the large diameter cylinder chamber being formed on a wall surface of the large diameter cylinder chamber, wherein the leaked fuel outflow port is covered for suppressing an outflow of leaked fuel from the leaked fuel outflow port.

### BRIEF DESCRIPTION OF THE DRAWINGS

FIG. 1 is an overview of a fuel injection apparatus,

FIG. 2 is a view of a first embodiment of an injected fuel pressure boosting device,

FIG. 3 is a view of a second embodiment of an injected fuel pressure boosting device,

FIG. 4 is a view showing a third embodiment of an injected fuel pressure boosting device,

FIG. 5 is a view showing a fourth embodiment of an injected fuel pressure boosting device,

FIG. 6 is a view showing a fifth embodiment of an injected fuel pressure boosting device,

FIG. 7 is a view showing a sixth embodiment of an injected fuel pressure boosting device,

FIG. 8 is a view showing a seventh embodiment of an injected fuel pressure boosting device,

FIG. 9 is a view showing an eighth embodiment of an injected fuel pressure boosting device,

FIG. 10 is a view showing a ninth embodiment of an injected fuel pressure boosting device,

FIG. 11 is a view showing a 10th embodiment of an injected fuel pressure boosting device,

FIG. 12 is a view showing an 11th embodiment of an injected fuel pressure boosting device,

FIG. 13 is a view showing a 12th embodiment of an injected fuel pressure boosting device,

FIG. 14 is a view showing a 13th embodiment of an injected fuel pressure boosting device,

FIG. 15 is a view showing a 14th embodiment of an injected fuel pressure boosting device,

FIG. 16 is a view showing a 15th embodiment of an injected fuel pressure boosting device,

FIG. 17 is a view showing a 16th embodiment of an injected fuel pressure boosting device,

FIG. 18 is a view showing a 17th embodiment of an injected fuel pressure boosting device,

FIG. 19 is a view showing an 18th embodiment of an injected fuel pressure boosting device,

FIG. 20 is a view showing a 19th embodiment of an injected fuel pressure boosting device,

FIG. 21 is a view showing a 20th embodiment of an injected fuel pressure boosting device,

FIG. 22 is a view showing a 21st embodiment of an injected fuel pressure boosting device,

FIG. 23 is a view showing a 22nd embodiment of an injected fuel pressure boosting device,

FIG. 24 is a view showing a 23rd embodiment of an injected fuel pressure boosting device,

FIG. 25 is a view showing a 24th embodiment of an injected fuel pressure boosting device,

FIG. 26 is a view showing a 25th embodiment of an injected fuel pressure boosting device, and

FIG. 27 is a view showing a 26th embodiment of an injected fuel pressure boosting device.

### BEST MODE FOR CARRYING OUT THE INVENTION

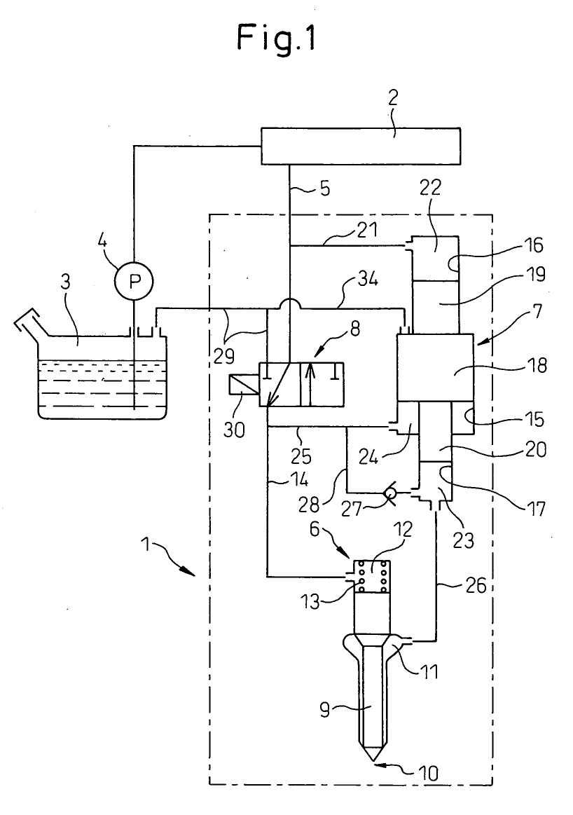

FIG. 1 schematically shows a fuel injection apparatus as a whole. In FIG. 1, the part 1 surrounded by the dot and dash line shows the fuel injector attached to the engine. As shown in FIG. 1, the fuel injection apparatus is provided with a common rail 2 for storing high pressure fuel. Into this common rail 2, fuel inside the fuel tank 3 is supplied through a high pressure fuel pump 4. The fuel pressure inside the common rail 2 is maintained at the target fuel pressure in accordance with the engine operating state by controlling the amount of discharge of the high pressure fuel pump 4. The high pressure fuel in the common rail 2 maintained at the target fuel pressure is supplied through a high pressure fuel supply passage 5 to the fuel injector 1.

As shown in FIG. 1, the fuel injector 1 is provided with a nozzle part 6 for injecting fuel into a combustion chamber, an injected fuel pressure boosting device 7 for increasing the pressure of the injected fuel, and a three-way valve 8 for switching the fuel passage fuel. The nozzle part 6 is provided with a needle valve 9. At the front end of the nozzle part 6, an injection port 10 (not shown) controlled to open and close by the front end of the needle valve 9 is formed. Around the needle valve 9, a nozzle chamber 11 filled with injected high pressure fuel is formed. At the top face of the needle valve 9, a back pressure chamber 12 filled with fuel is formed. Inside the back pressure chamber 12, a compression spring 13 biasing the needle valve 9 downward, that is, in the valve closing direction, is inserted. This pressure control chamber 12 is connected through a fuel flow passage 14 to the three-way valve 8.

The injected fuel pressure boosting device 7 is provided with a large diameter cylinder chamber 15, a medium diameter cylinder chamber 16 arranged coaxially at one end of the large diameter cylinder chamber 15, and a small diameter cylinder chamber 17 arranged coaxially at the other end of the large diameter cylinder chamber 15 and further is provided with a large diameter piston 18 arranged slidably in the large diameter cylinder chamber 15, a medium diameter piston 19 slidably inserted in the medium diameter cylinder chamber 16 and having a diameter smaller than the large diameter cylinder 18, and a small diameter piston 20 arranged slidably in the small diameter cylinder 17 and having a diameter smaller than the medium diameter cylinder 19.

The medium diameter piston 19 abuts against the end face of one end of the large diameter piston 18, while the small diameter piston 20 abuts against the end face of the other end of the large diameter piston 18. In this case, of course, the medium diameter piston 19 can be joined with the large diameter piston 18 or formed integrally with the large diameter piston 18, while the small diameter piston 20 can be joined with the large diameter piston 18 or formed integrally with the large diameter piston 18. Whatever the case, these large diameter piston 18, medium diameter piston 19, and small diameter piston 20 move all together.

At the end face of the outer end of the medium diameter piston 19, a high pressure chamber 22 connected through the high pressure fuel supply passages 21 and 5 to the common rail 2 is formed. The inside of this high pressure chamber 22 is filled with high pressure fuel at all times. On the other hand, at the end face of the outer end of the small diameter piston 20, a pressure boosting chamber 23 is formed, while at the end face of the large diameter piston 18 on the small diameter piston 20 side, a pressure control chamber 24 is formed. The pressure control chamber 24 is connected through a fuel flow passage 25 to the fuel flow passage 14. Further, the pressure boosting chamber 23 is on one hand connected through a fuel flow passage 26 to the nozzle chamber 11 and on the other hand connected through a check valve 27, enabling flow from the fuel flow passage 25 to only the pressure boosting chamber 23, and fuel flow passage 28 to the fuel flow passage 25.

On the other hand, in addition to the high pressure fuel supply passage 5 and fuel circulation passage 14, for example a low pressure fuel return passage 29 connected to the fuel tank 3 is connected to the three-way valve 8. This three-way valve 8 is driven by an actuator 30 such as a solenoid valve or piezoelectric actuator. Due to this three-way valve 8, the fuel flow passage 14 is selectively connected to the high pressure fuel supply passage 5 or low pressure fuel return passage 29.

FIG. 1 shows the case where the fuel flow passage 14 is connected with the high pressure fuel supply passage 5 by the fuel passage switching action by the three-way valve 8. In this case, the fuel pressure in the back pressure chamber 12 and the pressure control chamber 24 become the high pressure in the common rail 2 (hereinafter referred to as the “common rail pressure”). On the other hand, at this time, the high pressure fuel in the common rail 2 is supplied through the check valve 27 to the pressure boosting chamber 23 and nozzle chamber 11, so the pressure boosting chamber 24 and nozzle chamber 11 also become the common rail pressure.

At this time, compared with the force making the needle valve 9 rise due to the fuel pressure inside the nozzle chamber 11, the force making the needle valve 9 fall due to the fuel pressure in the back pressure chamber 12 and the spring force of the compression spring 13 is stronger, so the needle valve 9 is made to descend. As a result, the needle valve 9 closes, so the fuel injection from the injection port 10 is stopped. On the other hand, at this time, the force biasing the large diameter piston 18 and small diameter piston 20 upward in FIG. 1 is stronger than the force biasing the medium diameter piston 19 downward, so all of the pistons 18, 19, and 20 are at the top end position, that is, the pressure boosting preparation position where the volume of the pressure boosting chamber 23 becomes the greatest.

On the other hand, when the fuel flow passage 14 is connected with the low pressure fuel return passage 29 by the passage switching action of the three-way valve 8, the fuel pressure in the back pressure chamber 12 falls, so the needle valve 9 rises. As a result, the needle valve 9 opens and the fuel in the nozzle chamber 11 is injected from the injection port 10. On the other hand, at this time, the fuel pressure in the pressure control chamber 24 falls, so the force pushing down the large diameter piston 18 and the small diameter piston 20 becomes stronger than the force pushing up the large diameter piston 18 and the small diameter piston 20. Therefore, a large downward force acts on the small diameter piston 20. As a result, the fuel pressure in the pressure boosting chamber 23 becomes higher than the common rail pressure. Therefore, at this time, the fuel pressure in the nozzle chamber 11 connected through the fuel flow passage 26 to the inside of the pressure boosting chamber 23 becomes higher than even the common rail pressure. While fuel is being injected, it is maintained at this high fuel pressure. Therefore, if the needle valve 9 opens, fuel is injected from the injection port 10 by a higher injection pressure than the common rail pressure.

Next, when the fuel flow passage 14 is connected again to the high pressure fuel supply passage 5 as shown in FIG. 1 due to the fuel passage switching action by the three-way valve 8, the inside of the back pressure chamber 12 becomes the common rail pressure. As a result, the injection of fuel is stopped. Further, at this time, the inside of the pressure control chamber 24 becomes the common rail pressure and the inside of the pressure boosting chamber 23 also becomes the common rail pressure, so all of the pistons 18, 19, and 20 immediately return to the pressure boosting preparation positions shown in FIG. 1. In this way, the fuel injection is controlled by the fuel passage switching action by the three-way valve 8.

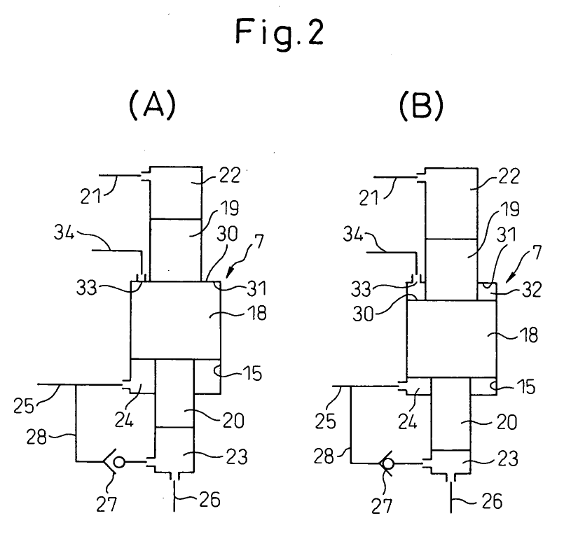

FIG. 2 shows only the injected fuel pressure boosting device 7 shown in FIG. 1 taken out. Note that in FIG. 2, (A) shows when the pistons 18, 19, and 20 have returned to the pressure boosting preparation positions, while (B) shows when the pressure boosting action is being performed. The same is true in the following embodiments as well.

Now, when high pressure fuel is supplied to the inside of the pressure control chamber 24, the high pressure fuel in the pressure control chamber 24 passes through the surroundings of the large diameter piston 18 and leaks to the inside of the end space 32 formed between the end face 30 of the large diameter piston 18, which is located on the medium diameter piston 19 side and the end face 31 of the large diameter cylinder chamber 15, which faces the end face 30 of this large diameter piston 18 (see FIG. 2(B)). The high pressure fuel in the high pressure chamber 22 also passes through the surroundings of the medium diameter piston 19 and leaks into the end space 32. The fuel leaked into the end space 32 is returned from the leaked fuel outflow port 33 through the low pressure fuel exhaust passage 34 and low pressure fuel exhaust passage 29 (see FIG. 1) to the inside of the fuel tank 3.

In this case, if the amount of leaked fuel exhausted from the leaked fuel exhaust port 33 increases, the energy loss for raising the pressure of the fuel increases. Therefore, in the present invention, the leaked fuel outflow port 33 is covered so as to suppress the outflow of leaked fuel from the leaked fuel outflow port 33. In this case, several methods may be considered for covering the leaked fuel outflow port 33. These method will be successively explained.

One method is the method of closing the leaked fuel outflow port 33 when the pressure control chamber 24 is supplied with high pressure fuel of the high pressure fuel source, that is, the common rail 2, and the large diameter piston 18 moves in a direction away from the pressure boosting chamber 23, and opening the leaked fuel outflow port 33 when the high pressure fuel inside the pressure control chamber 24 is exhausted from the pressure control chamber 24 and the large diameter piston 18 moves toward the pressure boosting chamber 23.

Typical among these methods is the method of forming the leaked fuel outflow port 33 so as to face the end face 30 of the large diameter piston 18 and using the end face 30 of the large diameter piston 18 to close the leaked fuel outflow port 33. The various embodiments for working this typical method are shown from FIG. 2 to FIG. 5.

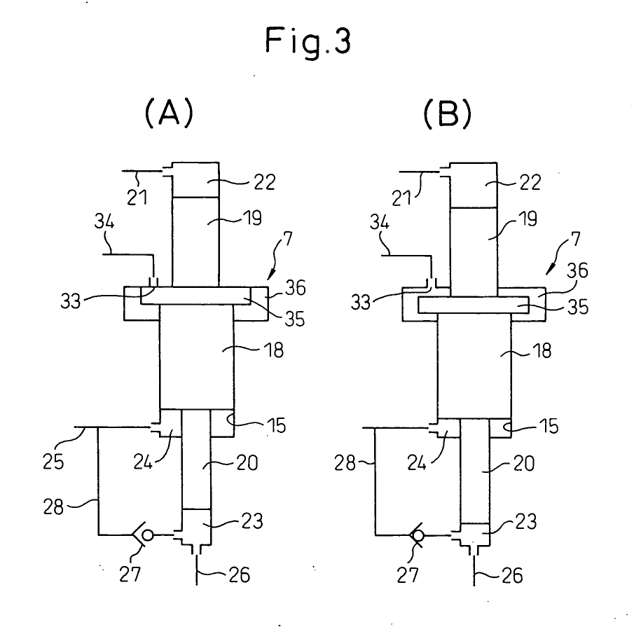

First, referring to the first embodiment shown in FIG. 2, the end face 30 of the large diameter piston 18 on the medium diameter piston 19 side is flat. The end face 31 of the large diameter cylinder chamber 15 facing the end face 30 of this large diameter piston 18 is also flat. The flat end face 31 of the large diameter cylinder chamber 15 is formed with the leaked fuel outflow port 33. In this first embodiment, in the same way as the other embodiment shown from FIG. 3 to FIG. 5, when the large diameter piston 18 returns to the pressure boosting preparation position shown in FIG. 2(A), the leaked fuel outflow port 33 is closed by the end face 30 of the large diameter piston 18 strongly pushed against the end face 31 of the large diameter cylinder chamber 15 by the high pressure fuel in the pressure control chamber 24 and pressure boosting chamber 23. As a result, the outflow of leaked fuel from the leaked fuel outflow port 33 can be completely prevented.

FIG. 3 shows a second embodiment. In this embodiment, the end of the large diameter piston 18 on the medium diameter piston 19 side is formed with a flange portion 35 projecting outward in the radial direction and a leaked fuel outflow port 33 facing the flange portion 35. Further, in this embodiment, to hold the flange portion 35, the end 36 of the large diameter cylinder chamber 15 on the medium diameter piston 19 side is expanded outward. If providing the flange portion 35 in this way, the space for forming the leaked fuel outflow port 33 is enlarged and therefore the leaked fuel outflow port 33 can be easily formed.

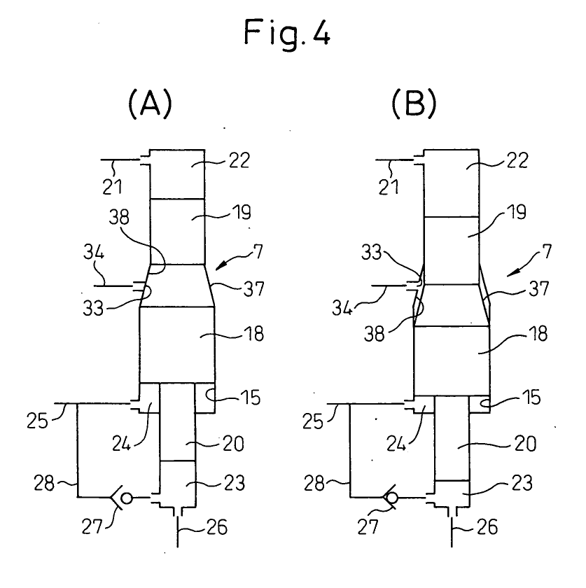

FIG. 4 shows a third embodiment. In this embodiment, the end 37 of the large diameter piston 18 on the medium diameter piston 19 side is formed into a conical shape. The end 38 of the large diameter cylinder chamber 15 facing the conically shaped end face 37 of this large diameter piston 18 is also formed into a conical shape. The leaked fuel outflow port 33 is formed on the conically shaped end 38 of the large diameter cylinder chamber 15. In this embodiment as well, the conically shaped end face 37 of the large diameter piston 18 is strongly pushed against the conically shaped end 38 of the large diameter cylinder chamber 15, so the outflow of leaked fuel from the leaked fuel outflow port 33 is completely stopped.

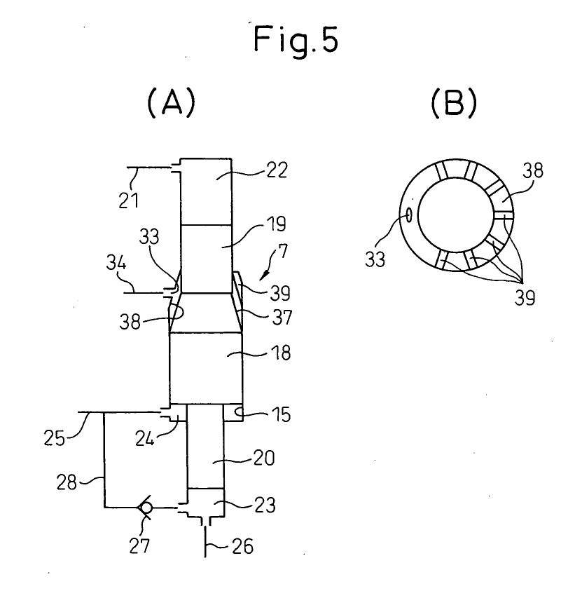

FIG. 5 shows a fourth embodiment. Note that in this FIG. 5, (A) shows when the pressure boosting action is being performed, while (B) shows a bottom view of the conically shaped end 38 of the large diameter cylinder chamber 15. As shown in FIG. 5, in this embodiment, grooves 39 for preventing sticking of the large diameter piston 18 is formed on the conically shaped end 38 of the large diameter cylinder chamber 15. That is, as explained above, in this embodiment, the conically shaped end face 37 of the large diameter piston 18 is strongly pushed against the conically shaped end 38 of the large diameter cylinder chamber 15, so there is a risk of the conically shaped end face 37 of the large diameter piston 18 sticking to the conically shaped end 38 of the large diameter cylinder chamber 18. However, if forming grooves 39 on the conically shaped end 38 of the large diameter cylinder chamber 18, not only does the contact area of the conically shaped end face 37 of the large diameter piston 18 and the conically shaped end 38 of the large diameter cylinder chamber 18 become smaller, but the leaked high pressure fuel flows into the grooves 39, so a downward force is generated and therefore the conically shaped end face 37 of the large diameter piston 18 can be prevented from sticking to the conically shaped end 38 of the large diameter cylinder chamber 18.

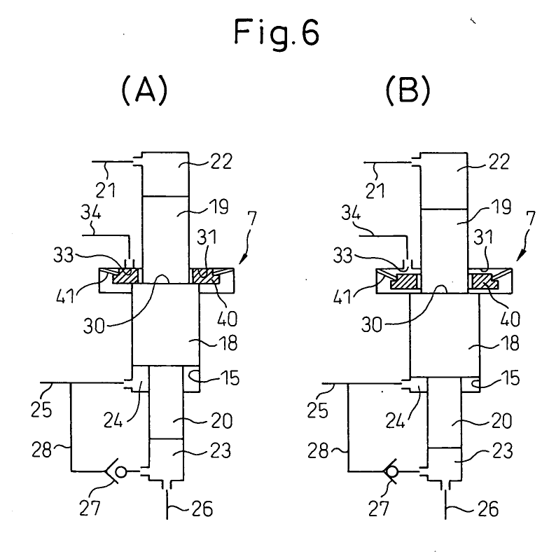

FIG. 6 shows a fifth embodiment. In this embodiment, at the end face 30 of the larger diameter piston 18 on the medium diameter piston 19 side, a ring-shaped plate 40 is loosely fitted around the medium diameter piston 19, while at the flat end face 31 of the large diameter cylinder chamber 15 facing the end face 30 of the large diameter piston 18, the leaked fuel outflow port 33 is formed. When the large diameter piston 18 moves to the medium diameter piston 19 side, the leaked fuel outflow port 33 is closed by the ring-shaped plate 40. In this embodiment as well, the leaked fuel outflow port 33 is completely closed by the ring-shaped plate 40. Note that in this embodiment, as shown in FIG. 6(B), a spring member 41 is attached at the ring-shaped plate 40 biasing the ring-shaped plate 40 in a direction away from the end face 31 of the large diameter cylinder chamber 15 so that when the pressure boosting action is performed, the ring-shaped plate 40 moves away from the end face 31 of the large diameter cylinder chamber 15.

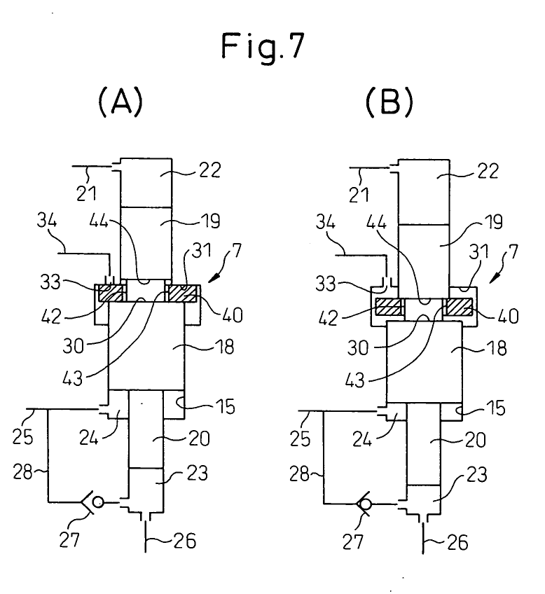

FIG. 7 shows a sixth embodiment. In this embodiment, the circumferential groove 42 is formed in the inner end part of the medium diameter piston 19, while the center hole 43 of a ring-shaped plate 40 is loosely fitted in this circumferential groove 42. As shown in FIG. 7, the outer end part of the circumferential groove 42 is defined by the ring-shaped step part 44, and the diameter of the center hole 43 of the ring-shaped plate 40 is formed smaller than the diameter of the medium diameter piston 19. Therefore, in this embodiment, when the large diameter piston 18 moves toward the pressure boosting chamber 23, the ring-shaped step part 44 abuts against the ring-shaped plate 40 and drags along the ring-shaped plate 40, whereby the ring-shaped plate 40 is pulled away from the end face 31 of the large diameter cylinder chamber 15.

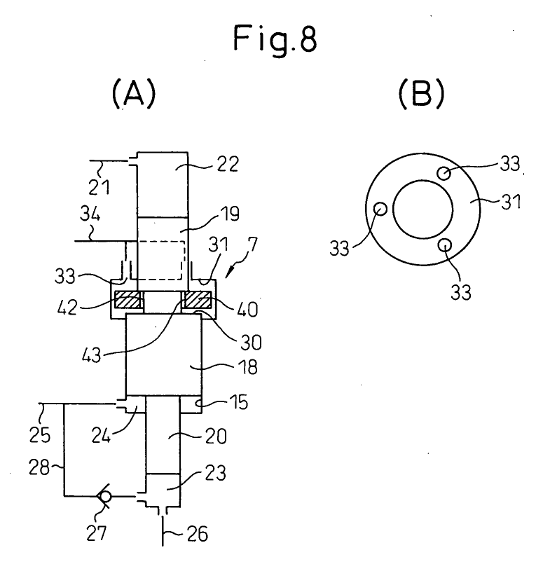

FIG. 8 shows a seventh embodiment. Note that in FIG. 8, (A) shows when a pressure boosting action is performed, while (B) shows a bottom view of the flat end face 31 of the large diameter cylinder chamber 15. Further, in this embodiment, in the same way as the embodiment shown in FIG. 7, the ring-shaped plate 40 is loosely fitted into the circumferential groove 42. The leaked fuel outflow port 33 is closed by this ring-shaped plate 40. In this embodiment, to prevent the ring-shaped plate 40 from tilting when being pulled away from the end face 31 of the large diameter cylinder chamber 15, a plurality of the leaked fuel outflow ports 33 are provided. The leaked fuel outflow ports 33 are formed dispersed on the flat end face 31 of the large diameter cylinder chamber 15.

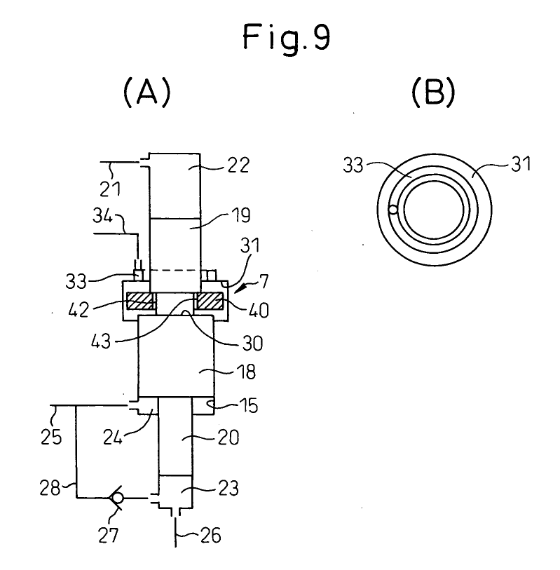

FIG. 9 shows an eighth embodiment. Note that in FIG. 9, (A) shows when a pressure boosting action is performed, while (B) shows a bottom view of the flat end face 31 of the large diameter cylinder chamber 15. Further, in this embodiment as well, in the same way as the embodiment shown in FIG. 7, the ring-shaped plate 40 is loosely fitted in the circumferential groove 42. The leaked fuel outflow port 33 is closed by this ring-shaped plate 40. In this embodiment as well, to prevent the ring-shaped plate 40 from tilting when being pulled away from the end face 31 of the large diameter cylinder chamber 15, the leaked fuel outflow ports 33 is comprised of a ring-shaped groove.

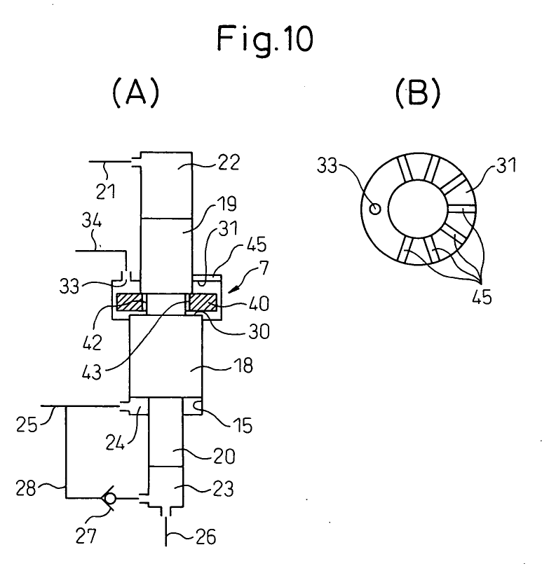

FIG. 10 shows a ninth embodiment. Note that in FIG. 10, (A) shows when a pressure boosting action is performed, while (B) shows a bottom view of the flat end face 31 of the large diameter cylinder chamber 15. Further, in this embodiment as well, in the same way as the embodiment shown in FIG. 7, the ring-shaped plate 40 is loosely fitted in the circumferential groove 42. The leaked fuel outflow port 33 is closed by this ring-shaped plate 40. In this embodiment, grooves 45 for preventing sticking of the large diameter piston 18 is formed on the flat end face 31 of the large diameter cylinder chamber 15.

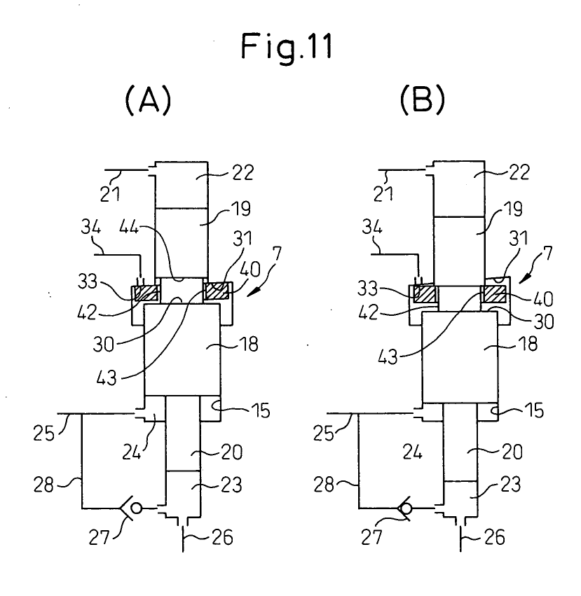

FIG. 11 shows a 10th embodiment. Note that in this embodiment as well, in the same way as the embodiment shown in FIG. 7, the ring-shaped plate 40 is loosely fitted in the circumferential groove 42. The leaked fuel outflow port 33 is closed by this ring-shaped plate 40. Now, in this embodiment, the ring-shaped step part 44 is formed in a plane vertical to the axis of the medium diameter piston 19, and the flat end face 31 of this large diameter cylinder chamber 15 is made to be tilted with respect to this plane. In this embodiment, when the pressure boosting action is started from the pressure boosting preparation position shown in FIG. 11(A) as shown in FIG. 11(B), the ring-shaped plate 40 is given a rotary force about the left end of the ring-shaped plate 40 in FIG. 11 whereby the ring-shaped plate 40 easily moves away from the end face 31 of the large diameter cylinder chamber 15.

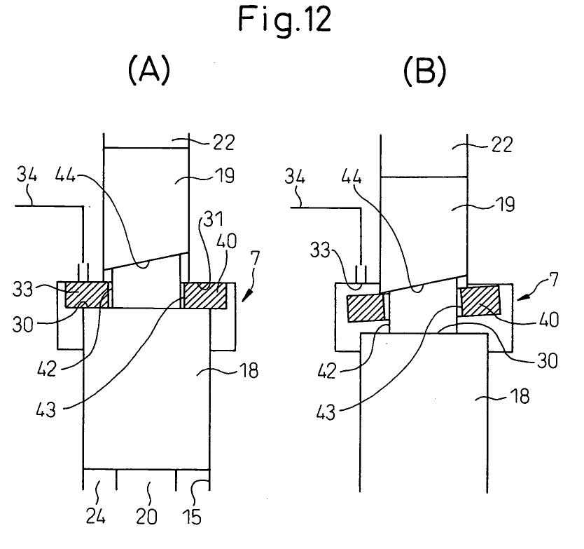

FIG. 12 shows an 11th embodiment. Note that in this embodiment as well, in the same way as the embodiment shown in FIG. 7, the ring-shaped plate 40 is loosely fitted in the circumferential groove 42. The leaked fuel outflow port 33 is closed by this ring-shaped plate 40. Now, in this embodiment, the flat end face 31 of the large diameter cylinder chamber 15 is arranged in the plane vertical to the axial line of the medium diameter piston 19, while the ring-shaped step part 44 of the circumferential groove 42 is formed in a plane tilted with respect to this plane. Therefore, in this embodiment, when the pressure boosting action is started from the pressure boosting preparation position shown in FIG. 12(A) as shown in FIG. 12(B), the ring-shaped plate 40 is given a rotary force about the right end of the ring-shaped plate 40 in FIG. 12 whereby the ring-shaped plate 40 easily is pulled away from the end face 31 of the large diameter cylinder chamber 15.

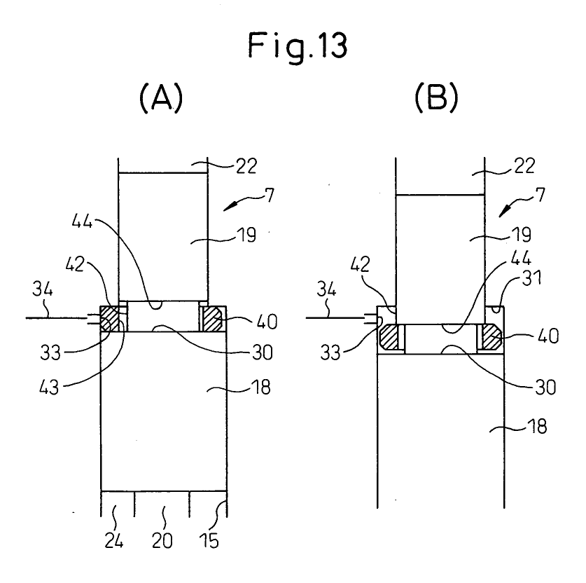

FIG. 13 to FIG. 16 show other embodiments. In these embodiments, in the same way as the embodiment shown in FIG. 7, the ring-shaped plate 40 is loosely fitted in the circumferential groove 42. However, in these embodiments, the leaked fuel outflow port 33 is formed on the inner circumferential wall of the large diameter cylinder chamber 15 on which the outer circumferential surface of the large diameter piston 18 slides, and this leaked fuel outflow port 33 is closed by this ring-shaped plate 40. That is, if explaining this taking as an example the 12th embodiment shown in FIG. 13, when the large diameter piston 18 moves toward the pressure boosting preparation position, due to the pressure difference between the high pressure acting inside the center hole 43 of the ring-shaped plate 40 and the low pressure inside the leaked fuel outflow port 33, the outer circumferential surface of the ring-shaped plate 40, as shown in FIG. 13(A), is pushed against the inner circumferential surface of the large diameter cylinder chamber 15 around the leaked fuel outflow port 33, therefore the leaked fuel outflow port 33 is completely closed by the ring-shaped plate 40.

On the other hand, when the pressure boosting action is started, the ring-shaped step part 44 abuts against the ring-shaped plate 40 and drags along the ring-shaped plate 40, therefore the ring-shaped plate 40 is pulled away from the inner circumference of the large diameter cylinder chamber 15.

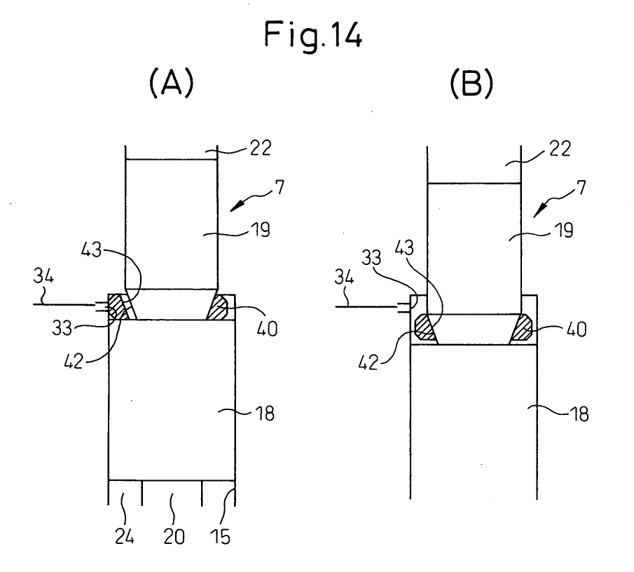

In the 13th embodiment shown in FIG. 14, the conically shaped circumferential groove 42 is formed in the inner end of the medium diameter piston 19. The conically shaped center hole 43 of the ring-shaped plate 40 is loosely fitted in this conically shaped circumferential groove 42. In this embodiment, when the pressure boosting action is started, that is, when the medium diameter piston 19 descends, the conically shaped circumferential groove 42 abuts against the conically shaped center hole 43 and drags along the ring-shaped plate 40. At this time, the ring-shaped plate 40 is pulled toward the center axial line of the medium diameter piston 19 and therefore the leaked fuel outflow port 33 is opened.

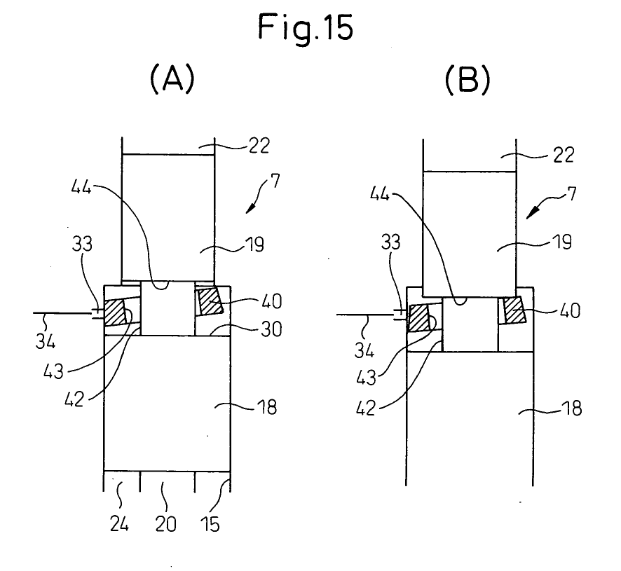

In the 14th embodiment shown in FIG. 15, the outer circumferential surface of the ring-shaped plate 40 is comprised of a conical surface, therefore the ring-shaped plate 40 closes the leaked fuel outflow port 33 in the state, as shown in FIG. 15(A), where it is tilted with respect to the flat end face 30 of the large diameter piston 18. When the pressure boosting action is started, as shown in FIG. 15(B), the ring-shaped step part 44 of the circumferential groove 42 abuts against the ring-shaped plate 40 and gives a rotary force about the left end of the ring-shaped plate 40 in FIG. 15. As a result, the ring-shaped plate 40 opens the leaked fuel inflow port 33.

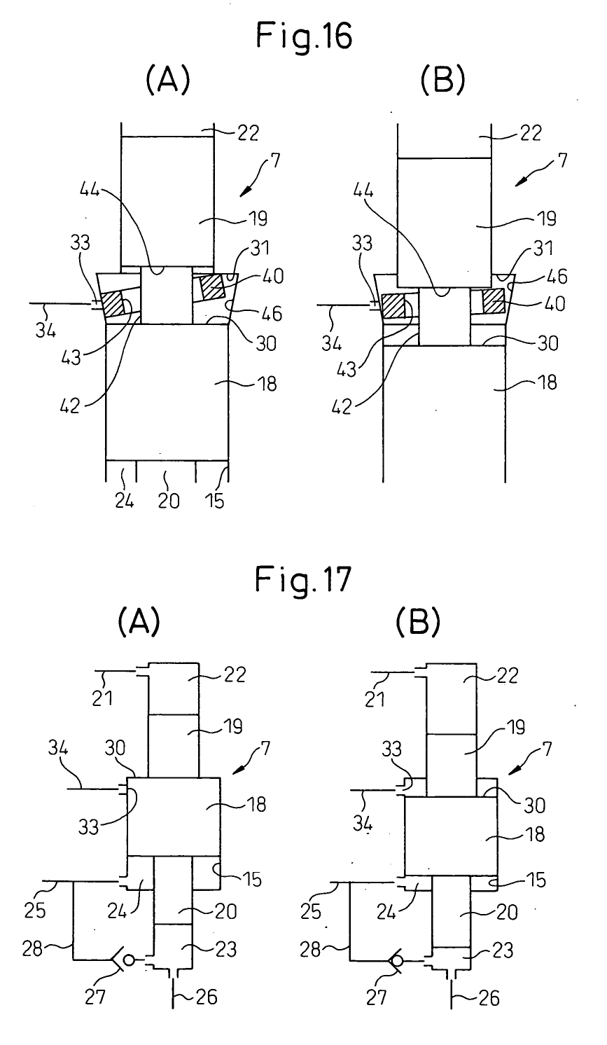

In the 15th embodiment shown in FIG. 16, the inner circumferential surface 46 of the end portion of the large diameter cylinder chamber 15 on the medium diameter cylinder 19 side is formed into a conical shape, and the leaked fuel outflow port 33 is formed on the conically shaped inner circumferential surface 46 of this large diameter cylinder chamber 15. In this embodiment, the outer circumferential surface of the ring-shaped plate 40 is formed into a cylindrical shape, therefore the ring-shaped plate 40 closes the leaked fuel outflow port 33, as shown in FIG. 16(A), in the state tilted with respect to the flat end face 30 of the large diameter piston 18. When the pressure boosting action is started, as shown in FIG. 16(B), the ring-shaped step part 44 of the circumferential groove 42 abuts against the ring-shaped plate 40 and gives a rotary force about the left end of the ring-shaped plate 40 in FIG. 16. As a result, the ring-shaped plate 40 opens the leaked fuel inflow port 33.

FIG. 17 shows a 16th embodiment. In this embodiment, the leaked fuel outflow port 33 is formed on the inner circumferential wall of the large diameter cylinder chamber 15 on which the outer circumferential surface of the large diameter piston 18 slides. When the large diameter piston 18 moves toward the medium diameter piston 19, this leaked fuel outflow port 33 is closed by the outer circumferential surface of the large diameter piston 18.

In this embodiment, the leaked fuel outflow port 33, as shown FIG. 17(A), is formed closer to the pressure control chamber 24 side than the flat end face 30 of the large diameter piston 18 when the large diameter piston 18 is at the pressure boosting preparation position. Therefore, when the large diameter piston 18 returns to the pressure boosting preparation position, the leaked fuel outflow port 33 is closed by the large diameter piston 18. However, at this time as well, the leaked fuel flows on the outer circumference of the large diameter piston 18, so while the amount of leaked fuel exhausted can be reduced, the outflow of leaked fuel cannot be completely prevented. The same is true in the following embodiments as well.

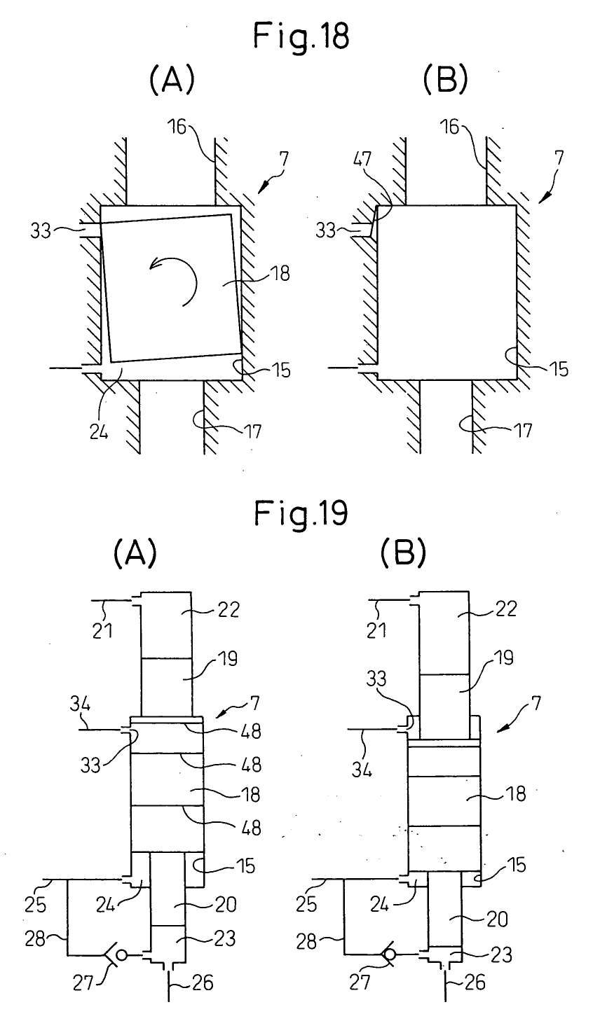

FIG. 18 shows a 17th embodiment. Note that in FIG. 18, (A) shows only the large diameter cylinder chamber 15 and the large diameter piston 18, while (B) shows only the large diameter cylinder chamber 15. Now, when high pressure fuel is supplied to the pressure control chamber 24 and the large diameter piston 18 rises and the top end of the large diameter piston 18, as shown in FIG. 18(A), reaches the leaked fuel outflow port 33, the pressure inside the leaked fuel outflow port 33 is low, so the top edge of the large diameter piston 18 is pulled toward the leaked fuel outflow port 33 side. As a result, the large diameter piston 18 is tilted just slightly with respect to the axis. When the axis of the large diameter piston 18 is tilted just slightly in this way, the high pressure fuel in the pressure control chamber 24 causes a large torque such as shown by the arrows to be generated at the large diameter piston 18. As a result, the top edge of the large diameter piston 18 strongly bites into the leaked fuel outflow port 33 and therefore the top edge of the large diameter piston 18 and the leaked fuel outflow port 33 are damaged.

Therefore, in this embodiment, to prevent the top edge of the large diameter piston 18 and the leaked fuel outflow port 33 from being damaged, as shown in FIG. 18(B), a recessed groove 47 is formed on the inner circumferential surface of the large diameter cylinder chamber 15, and the leaked fuel outflow port 33 is open at the deep portion of this recessed groove 47.

FIG. 19 to FIG. 23 show various embodiments in which, in the same way as FIG. 17, the leaked fuel outflow port 33 is formed on the inner circumferential surface of the large diameter cylinder chamber 15 and the leaked fuel outflow port 33 is closed by the outer circumferential surface of the large diameter piston 18 when the large diameter piston 18 moves toward the medium diameter piston 19.

That is, in an 18th embodiment shown in FIG. 19, a plurality of circumferential grooves 48 forming a labyrinth are formed on the outer circumferential surface of the large diameter piston 18. Further, in this embodiment, when the large diameter piston 18 moves to a position farthest from the pressure boosting chamber 23, that is, the large diameter piston 18 reaches the pressure boosting preparation position, as shown in FIG. 19(A), the circumferential grooves 48 are formed so that the leaked fuel outflow port 33 is positioned between a pair of circumferential grooves 48. As shown in FIG. 19(A), if circumferential grooves 48 forming a labyrinth are formed at the two sides of the leaked fuel outflow port 33, the amount of leaked fuel exhausted can be considerably reduced.

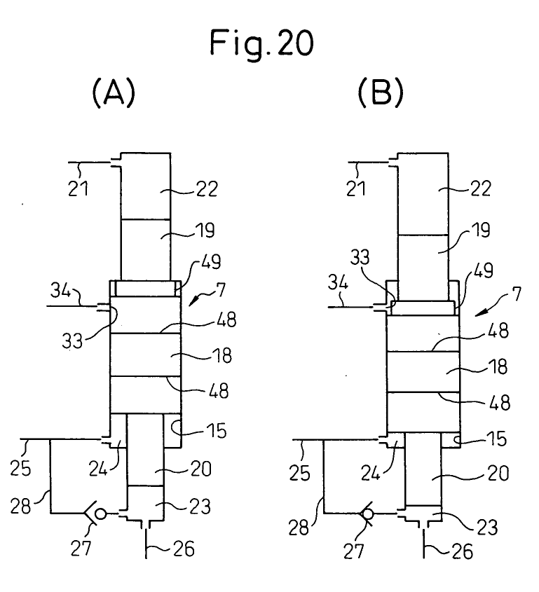

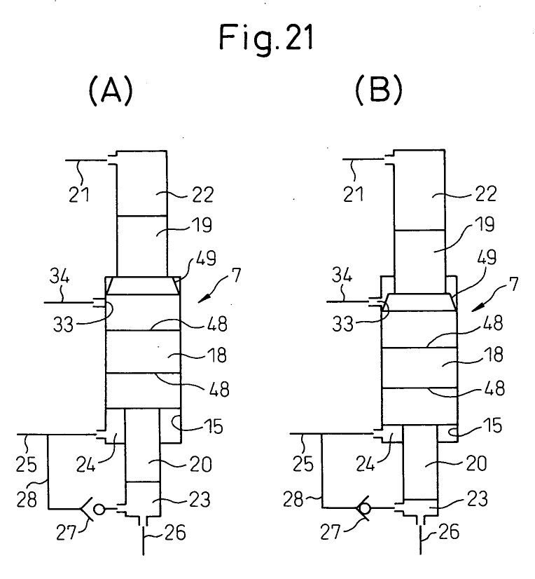

In the 19 embodiment shown in FIG. 20 and the 20th embodiment shown in FIG. 21, as shown in FIG. 20 and FIG. 21, a plurality of the circumferential grooves 48 forming a labyrinth are formed on the outer circumferential surface of the large diameter piston 18. Further, a cutaway portion 49 is formed extending across the broader width compared with the circumferential grooves 48 at the outer circumferential surface of the end portion of the large diameter piston 18 on the medium diameter piston 19 side. In the embodiment shown in FIG. 20, this cutaway portion 49 has an L-cross-section, while in the embodiment shown in FIG. 21, this cutaway portion 19 has a triangular cross-section.

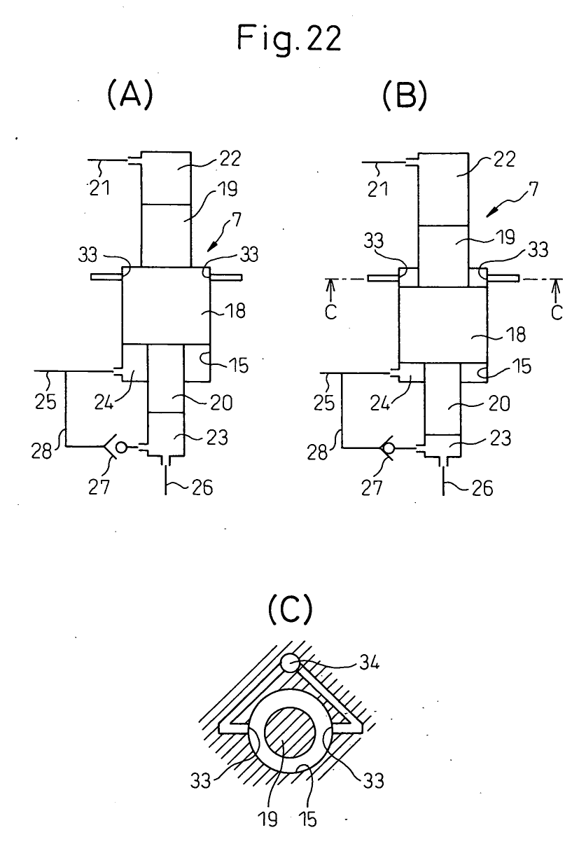

In the 21st embodiment shown in FIG. 22, a pair of the leaked fuel outflow ports 33 are formed at the opposite sides of the axis of the large diameter piston 18 so that the large diameter piston 18 does not tilt with respect to the axis of the large diameter cylinder chamber 15. Note that in FIG. 22, (C) shows the cross-section seen along the line C-C of FIG. 22(B). As will be understood from FIG. 22(C), the leaked fuel flowing into the leaked fuel outflow ports 33 is sent into the common low pressure fuel return passage 34.

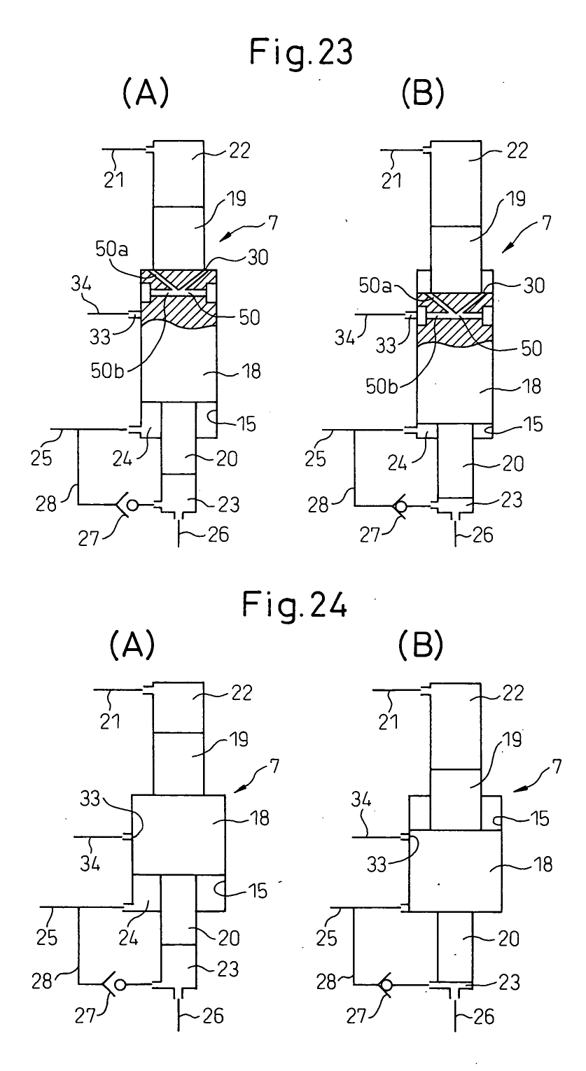

In the 22nd embodiment shown in FIG. 23, a fuel passage 50 opening on the end face 30 of the large diameter piston 18 on the medium diameter piston 19 side is formed inside the large diameter piston 18. This fuel passage 50 is comprised of a passage part 50a opening at the end face 30 of the large diameter piston 18 and a passage part 50b extending across the diameter of the large diameter piston 18. When the large diameter piston 18 moves toward the pressure boosting chamber 23, the fuel passage 50 is communicated with the leaked fuel outflow port 33.

FIG. 24 to FIG. 27 show various embodiments forming the leaked fuel outflow port 33 on the inner circumferential surface of the large diameter cylinder chamber 18 and covering the leaked fuel outflow port 33 at all times by the outer circumferential surface of the large diameter piston 18. If using the outer circumferential surface of the large diameter piston 18 to cover the leaked fuel outflow port 33 at all times in this way, the amount of leaked fuel exhausted can be considerably reduced. The 23rd embodiment shown in FIG. 24 shows a typical example using the outer circumferential surface of the large diameter piston 18 to cover the leaked fuel outflow port 33 at all times.

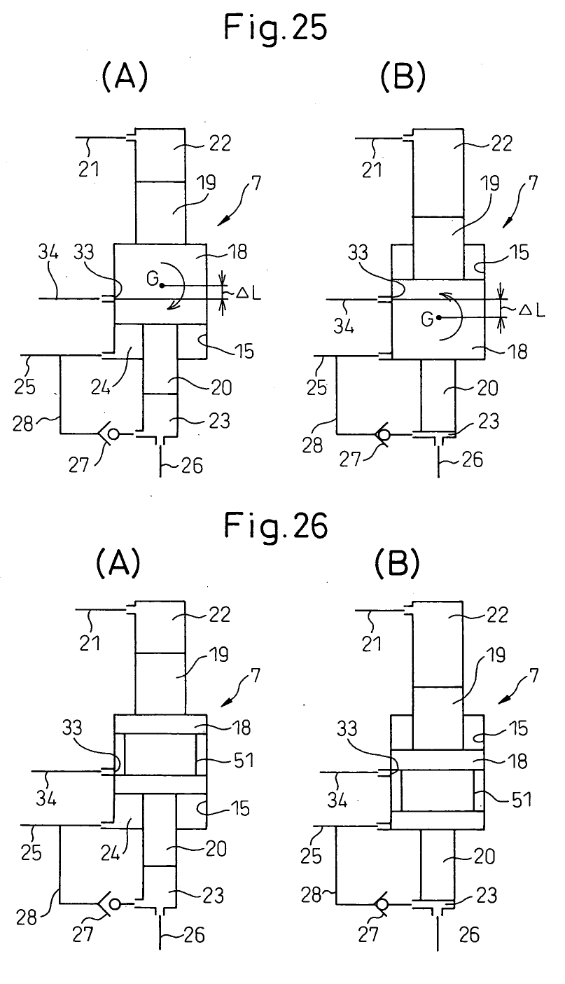

In the 24th embodiment shown in FIG. 25, as shown in FIG. 25(A), the distance ΔL between the center position of the large diameter piston 18 when moving to the position farthest from the pressure boosting chamber 23, that is, the center of gravity G, and the leaked fuel outflow port 33 and the distance ΔL between the center position of the large diameter piston 18 when moving to the position closest to the pressure boosting chamber 23, that is, the center of gravity G, and the leaked fuel outflow port 33 are made equal. That is, the leaked fuel outflow port 33 is formed at the center between the center position of the large diameter piston 18 when moving to the position most separate from the pressure boosting chamber 23, that is, the center of gravity G, and the center position of the large diameter piston 18 when moving to the position closest to the pressure boosting chamber 23, that is, the center of gravity G.

That is, since the pressure inside the leaked fuel inflow port 33 is low, in the state of FIG. 25(A), a torque in the arrow direction acts on the large diameter piston 18, while in the state of FIG. 25(B), a torque in the arrow direction acts on the large diameter piston 18. In this case, if the leaked fuel outflow port 33 is formed at the position shown in FIG. 25, these torques become the smallest, therefore the tilt angle of the large diameter piston 18 can be made the smallest.

In the 25th embodiment shown in FIG. 26, a circumferential groove 51 is formed on the outer circumferential surface of the large diameter piston 18, and the leaked fuel outflow port 33 opens into the circumferential groove 51 at all times.

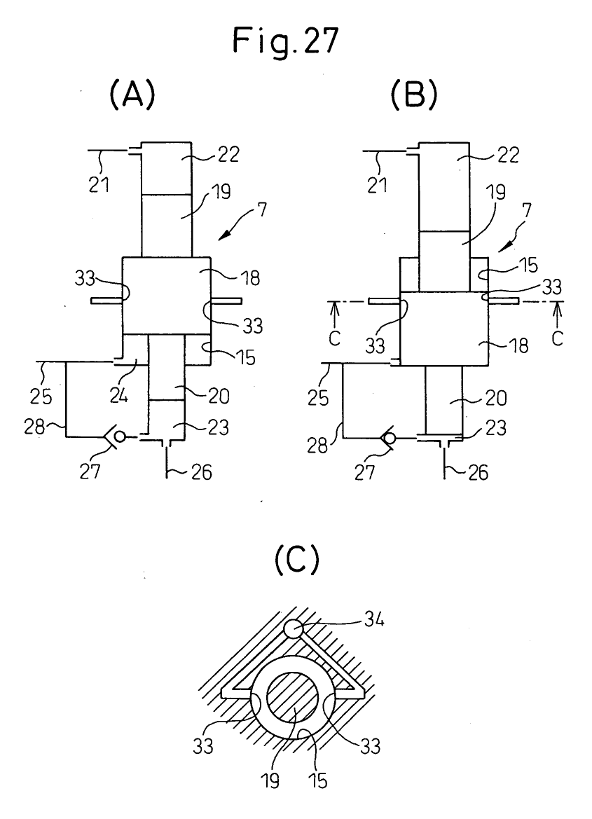

In the 26th embodiment shown in FIG. 27, a pair of the leaked fuel outflow ports 33 are formed at the opposite sides of the axis of the large diameter piston 18 so that the large diameter piston 18 is not tilted with respect to the axis of the large diameter cylinder chamber 15. Note that in FIG. 27, (C) shows a cross-section seen along the line C-C of FIG. 27(B). As will be understood from FIG. 27(C), the leaked fuel flowing into the leaked fuel outflow ports 33 is fed into the common low pressure fuel return passage 34.

### LIST OF REFERENCE NUMERALS

7 . . . injected fuel pressure boosting device
15 . . . large diameter cylinder chamber
18 . . . large diameter piston
19 . . . medium diameter piston
20 . . . small diameter piston
22 . . . high pressure chamber
23 . . . pressure boosting chamber
24 . . . pressure control chamber
33 . . . leaked fuel outflow port

1. An injected fuel pressure boosting device provided with a large diameter piston slidably inserted into a large diameter cylinder chamber and a pair of pistons respectively arranged coaxially with two ends of the large diameter piston in the axial direction and having diameters smaller than the large diameter piston, a pressure boosting chamber for increasing a pressure of injected fuel being formed on an outer end face of one piston among the pair of pistons, a pressure control chamber being formed on an end face of the large diameter piston on the pressure boosting chamber side, a pressure boosting action of the injected fuel being controlled by controlling a fuel pressure in the pressure control chamber, and a leaked fuel outflow port for making a fuel leaked from the pressure control chamber through a periphery of the large diameter piston flow out from the large diameter cylinder chamber being formed on a wall surface of the large diameter cylinder chamber, wherein the leaked fuel outflow port is covered for suppressing an outflow of leaked fuel from the leaked fuel outflow port.

2. An injected fuel pressure boosting device as set forth in claim 1, wherein a high pressure fuel source is provided, said pair of pistons are comprised of a small diameter piston and a medium diameter piston having a diameter larger than said small diameter piston, said pressure boosting chamber is formed on an outer end face of said small diameter piston and high pressure fuel of said high pressure fuel source is fed to an inside of said pressure boosting chamber, a high pressure chamber communicating with said high pressure fuel source is formed in an outer end of said medium diameter piston, and a pressure boosting action of injected fuel is performed when high pressure fuel of the high pressure fuel source, which is supplied to said pressure control chamber, is exhausted from the pressure control chamber.

3. An injected fuel pressure boosting device as set forth in claim 1, wherein a high pressure fuel source is provided, said leaked fuel outflow port is closed when high pressure fuel of said high pressure fuel source is supplied to the inside of said pressure control chamber and said large diameter piston moves in a direction away from said pressure boosting chamber, and said leaked fuel outflow port is opened when the high pressure fuel in said pressure control chamber is exhausted from the pressure control chamber and said large diameter piston moves toward said pressure boosting chamber.

4. An injected fuel pressure boosting device as set forth in claim 3, wherein said leaked fuel outflow port is formed facing an end face of the large diameter piston, which is located on the opposite side of said pressure boosting chamber.

5. An injected fuel pressure boosting device as set forth in claim 4, wherein when the large diameter piston moves in a direction away from said pressure boosting chamber, said leaked fuel outflow port is closed by the end face of the large diameter piston, which is located on the opposite side of said pressure boosting chamber.

6. An injected fuel pressure boosting device as set forth in claim 5, wherein said end face of the large diameter piston, which is located on the opposite side of said pressure boosting chamber, is flat, an end face of said large diameter cylinder chamber, which faces said end face of the large diameter piston, is flat, and said leaked fuel outflow port is formed on the flat end face of said large diameter cylinder chamber.

7. An injected fuel pressure boosting device as set forth in claim 6, wherein a flange portion projecting outward in the radial direction is formed at the end of the large diameter piston, which is located on the opposite side of said pressure boosting chamber, and said leaked fuel outflow port is formed facing said plunger part.

8. An injected fuel pressure boosting device as set forth in claim 5, wherein the end of the large diameter piston, which is located on the opposite side of said pressure boosting chamber, is formed into a conical shape, an end portion of said large diameter cylinder chamber, which faces the conically shaped end face of said large diameter piston is also formed into a conical shape, and said leaked fuel outflow port is formed on the conically shaped end of said large diameter cylinder chamber.

9. An injected fuel pressure boosting device as set in claim 8, wherein grooves for preventing sticking of the large diameter piston are formed on the conically shaped end face of said large diameter cylinder chamber.

10. An injected fuel pressure boosting device as set forth in claim 4, wherein at the end face of the large diameter piston, which is located on the opposite side of said pressure boosting chamber, a ring-shaped plate is loosely fitted around the other piston among said pair of pistons, said leaked fuel outflow port is formed on a flat end face of said large diameter cylinder chamber, which faces said end face of the large diameter piston, and said leaked fuel outflow port is closed by said ring-shaped plate when the large diameter piston moves in a direction away from said pressure boosting chamber.

11. An injected fuel pressure boosting device as set forth in claim 10, wherein said ring-shaped plate is provided with a spring member biasing said ring-shaped plate in a direction moving away from the flat end face of the large diameter cylinder chamber.

12. An injected fuel pressure boosting device as set forth in claim 10, wherein a circumferential groove is formed on an inside end of said other piston and said ring-shaped plate is loosely fitted in said circumferential groove, an outer end of said circumferential groove is defined by the ring-shaped step part, and said ring-shaped step part abuts against said ring-shaped plate and drags along the ring-shaped plate when the large diameter piston moves toward said pressure boosting chamber.

13. An injected fuel pressure boosting device as set forth in claim 12, wherein said ring-shaped step part is formed in a plane vertical to the axis of said other piston, and a flat end face of said large diameter cylinder chamber is tilted with respect to said plane.

14. An injected fuel pressure boosting device as set forth in claim 12, wherein a flat end face of said large diameter cylinder chamber is arranged in a plane vertical to the axis of said other piston and said ring-shaped step part is formed in a plane tilted with respect to said plane.

15. An injected fuel pressure boosting device as set forth in claim 10, wherein a plurality of said leaked fuel outflow ports are provided, and said leaked fuel outflow ports are formed dispersed on the flat end face of said large diameter cylinder chamber.

16. An injected fuel pressure boosting device as set forth in claim 10, wherein said leaked fuel outflow port is comprised of a ring-shaped groove.

17. An injected fuel pressure boosting device as set forth in claim 10, wherein grooves for preventing sticking of the large diameter piston are formed on a flat end face of said large diameter cylinder chamber.

18. An injected fuel pressure boosting device as set forth in claim 3, wherein said leaked fuel outflow port is formed on an inner circumferential surface of said large diameter cylinder chamber on which the outer circumferential surface of said large diameter piston slides.

19. An injected fuel pressure boosting device as set forth in claim 18, wherein said leaked fuel outflow port is closed by the outer circumferential surface of large diameter piston when the large diameter piston moves in a direction away from said pressure boosting chamber.

20. An injected fuel pressure boosting device as set forth in claim 19, wherein a recessed groove is formed on an inner circumferential surface of the large diameter cylinder chamber and said leaked fuel outflow port is formed in a deep interior of said recessed groove.

21. An injected fuel pressure boosting device as set forth in claim 19, wherein a plurality of circumferential grooves forming a labyrinth is formed on the outer circumferential surface of said large diameter piston.

22. An injected fuel pressure boosting device as set forth in claim 21, wherein said leaked fuel outflow port is positioned between a pair of said circumferential grooves when the large diameter piston moves to a position farthest from said pressure boosting chamber.

23. An injected fuel pressure boosting device as set forth in claim 21, wherein a cutaway portion is formed on an outer circumferential surface of the end portion of the large diameter piston, which is located on the opposite side of said pressure boosting chamber, over a broader width than said circumferential grooves.

24. An injected fuel pressure boosting device as set forth in claim 19, wherein said leaked fuel outflow ports are formed at opposite sides of the axis of the large diameter piston.

25. An injected fuel pressure boosting device as set forth in claim 19, wherein a fuel passage opening at an end face of the large diameter piston, which is located on the opposite side of said pressure boosting chamber is formed in the large diameter piston, and said fuel passage is communicated with said leaked fuel outflow port when the large diameter piston moves toward said pressure boosting chamber.

26. An injected fuel pressure boosting device as set forth in claim 18, wherein at an end face of the large diameter piston, which is located on the opposite side of said pressure boosting chamber, a ring-shaped plate is loosely fitted around the other piston among said pair of pistons, and said leaked fuel outflow port is closed by an outer circumferential surface of said ring-shaped plate when the large diameter piston moves in the direction away from said pressure boosting chamber.

27. An injected fuel pressure boosting device as set forth in claim 26, wherein a circumferential groove is formed at an inner end portion of said other piston and said ring-shaped plate is loosely fitted in said circumferential groove, an outer end of said circumferential groove is defined by the ring-shaped step part, and said ring-shaped step part abuts against said ring-shaped plate and drags along the ring-shaped plate when the large diameter piston moves toward said pressure boosting chamber.

28. An injected fuel pressure boosting device as set forth in claim 27, wherein an outer circumferential surface of said ring-shaped plate is formed into a conical surface.

29. An injected fuel pressure boosting device as set forth in claim 27, wherein an inner circumferential surface of an end portion of said large diameter cylinder chamber, which is located on the opposite side of said pressure boosting chamber, is formed into a conical shape, said leaked fuel outflow port is formed on the conically shaped inner circumferential surface of said large diameter cylinder chamber, and an outer circumferential surface of said ring-shaped plate has a cylindrical shape.

30. An injected fuel pressure boosting device as set forth in claim 26, wherein a conically shaped circumferential groove is formed at an inner end portion of said other piston, a conically shaped center hole of said ring-shaped plate is loosely fitted in said conically shaped circumferential groove, and said conically shaped circumferential groove abuts against said conically shaped center hole and drags along the ring-shaped plate when the large diameter piston moves toward said pressure boosting chamber.

31. An injected fuel pressure boosting device as set forth in claim 1, wherein said leaked fuel outflow port is formed on an inner circumferential surface of said large diameter cylinder chamber and said leaked fuel outflow port is covered by the outer circumferential surface of the large diameter piston at all times.

32. An injected fuel pressure boosting device as set forth in claim 31, wherein said leaked fuel outflow port is formed at the center between a center position of the large diameter piston when moving to a position farthest from said pressure boosting chamber and a center position of the large diameter piston when moving to a position closest to said pressure boosting chamber.

33. An injected fuel pressure boosting device as set forth in claim 31, wherein a circumferential groove is formed on the outer circumferential surface of said large diameter piston and said leaked fuel outflow port opens inside said circumferential groove at all times.

34. An injected fuel pressure boosting device as set forth in claim 31, wherein said leaked fuel outflow ports are formed at opposite sides with respect to an axis of the large diameter piston.
